(19) United States
(12) Patent Application Publication
(10) Pub. No.: US 2026/0235982 A1
(43) Pub. Date: Aug. 13, 2026

(54) HEATING DEVICE, FIXING DEVICE, AND IMAGE FORMING APPARATUS

(71) Applicants: Yasunori Ishigaya, Kanagawa (JP); Hiroyuki Shimada, Tokyo (JP)

(72) Inventors: Yasunori Ishigaya, Kanagawa (JP); Hiroyuki Shimada, Tokyo (JP)

(73) Assignee: ETRIA Co., Ltd., Kanagawa (JP)

(21) Appl. No.: 19/413,855

(22) Filed: Dec. 9, 2025

(30) Foreign Application Priority Data
Feb. 10, 2025 (JP) 2025-019976

(51) Int. Cl. G03G 15/20; G03G 15/00

(52) U.S. Cl. CPC G03G 15/2057; G03G 15/2064; G03G 15/80; G03G 2215/2019; G03G 2215/2035

(57) ABSTRACT

A heating device includes a heater that is laminated and a heated member that is heated by the heater. The heater includes a base layer and a resistive heat generator mounted on the base layer. The resistive heat generator extends in a longitudinal direction of the heater. The resistive heat generator includes a first heat generating portion and a second heat generating portion. The first heat generating portion has a first thickness and generates heat in a first heat generation amount. The second heat generating portion is disposed in a lateral end span of the resistive heat generator in the longitudinal direction of the heater and has a second thickness that is greater than the first thickness of the first heat generating portion. The second heat generating portion generates heat in a second heat generation amount smaller than the first heat generation amount of the first heat generating portion.

### CROSS-REFERENCE TO RELATED APPLICATION

This patent application is based on and claims priority pursuant to 35 U.S.C. §119(a) to Japanese Patent Application No. 2025-019976, filed on February 10, 2025, in the Japan Patent Office, the entire disclosure of which is hereby incorporated by reference herein.

### BACKGROUND

### TECHNICAL FIELD

The present disclosure relates to a heating device, a fixing device, and an image forming apparatus, and more particularly, to a heating device, a fixing device incorporating the heating device, and an image forming apparatus incorporating the fixing device.

### RELATED ART

Related-art image forming apparatuses, such as copiers, facsimile machines, printers, and multifunction peripherals (MFP) having two or more of copying, printing, scanning, facsimile, plotter, and other functions, typically form an image on a recording medium according to image data.

Such image forming apparatuses include a fixing device including a heating device. The heating device includes a fixing belt serving as a heated member that is heated by a heater. In a case that a plurality of sheets having a decreased size is conveyed over the fixing belt continuously, a non-conveyance span where the sheets are not conveyed is formed in a lateral end span of the fixing belt in a longitudinal direction thereof. The sheets do not draw heat from the fixing belt in the non-conveyance span. Accordingly, the fixing belt may overheat in the non-conveyance span.

### SUMMARY

The present disclosure described herein provides a heating device that includes a heater that is laminated and a heated member that is heated by the heater. The heater includes a base layer and a resistive heat generator mounted on the base layer. The resistive heat generator extends in a longitudinal direction of the heater. The resistive heat generator includes a first heat generating portion and a second heat generating portion. The first heat generating portion has a first thickness and generates heat in a first heat generation amount.

The second heat generating portion is disposed in a lateral end span of the resistive heat generator in the longitudinal direction of the heater and has a second thickness that is greater than the first thickness of the first heat generating portion. The second heat generating portion generates heat in a second heat generation amount that is smaller than the first heat generation amount of the first heat generating portion.

The present disclosure described herein further provides a fixing device that includes the above-described heating device that heats a recording medium bearing an image and a pressure rotator that is disposed opposite the heating device. The pressure rotator fixes the image on the recording medium together with the heating device.

The present disclosure described herein further provides an image forming apparatus that includes an image forming device that forms an image and the above-described fixing device that fixes the image on a recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure;

FIG. 2 is a schematic cross-sectional view of a fixing device according to an embodiment of the present disclosure that is incorporated in the image forming apparatus depicted in FIG. 1;

FIG. 3 is a perspective view of the fixing device depicted in FIG. 2;

FIG. 4 is an exploded perspective view of the fixing device depicted in FIG. 3;

FIG. 5 is a perspective view of a heating device incorporated in the fixing device depicted in FIG. 4;

FIG. 6 is an exploded perspective view of the heating device depicted in FIG. 5;

FIG. 7 is a plan view of a heater incorporated in the heating device depicted in FIG. 6;

FIG. 8 is an exploded perspective view of the heater depicted in FIG. 7;

FIG. 9 is a perspective view of the heater and a heater holder incorporated in the fixing device depicted in FIG. 2, illustrating a connector attached to the heater and the heater holder;

FIG. 10 is a side cross-sectional view of the heater depicted in FIG. 7;

FIG. 11 is a side cross-sectional view of a heater as a first modification example of the heater depicted in FIG. 10;

FIG. 12 is a plan view of a heater as a second modification example of the heater depicted in FIG. 10;

FIG. 13 is a plan view of a heater as a third modification example of the heater depicted in FIG. 10;

FIG. 14 is a plan view of a heater as a fourth modification example of the heater depicted in FIG. 10;

FIG. 15 is a side cross-sectional view of a heater according to an embodiment of the present disclosure, that is incorporated in a fixing device that employs an edge-reference conveyance method and is installable in the image forming apparatus depicted in FIG. 1;

FIG. 16 is a schematic cross-sectional view of a fixing device as a first variation of the fixing device depicted in FIG. 2;

FIG. 17 is a schematic cross-sectional view of a fixing device as a second variation of the fixing device depicted in FIG. 2; and

FIG. 18 is a schematic cross-sectional view of a fixing device as a third variation of the fixing device depicted in FIG. 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, a description is provided of embodiments of the present disclosure. In the drawings, identical reference numerals are assigned to identical elements and equivalents and redundant descriptions of the identical elements and the equivalents are summarized or omitted properly.

A description is provided of an overall construction of an image forming apparatus 1000.

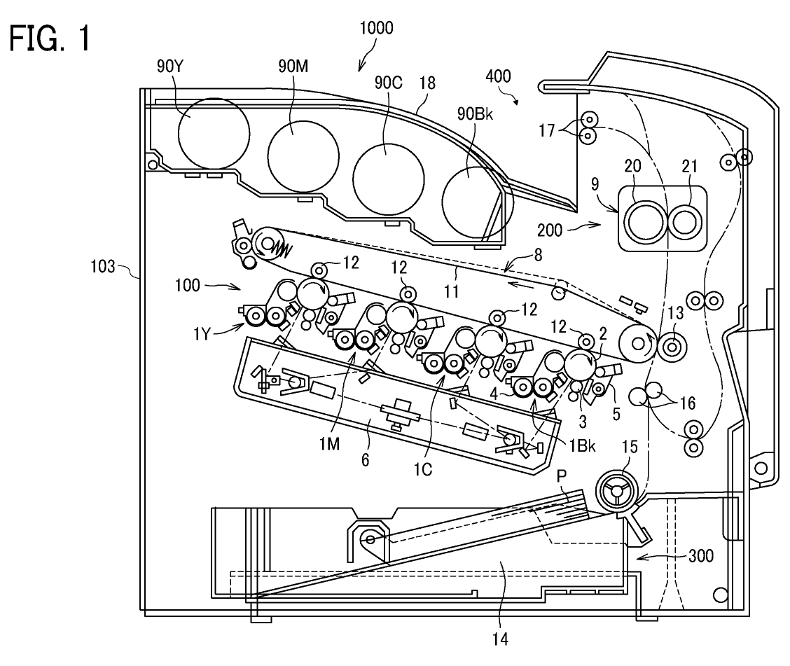

FIG. 1 is a schematic cross-sectional view of the image forming apparatus 1000 according to an embodiment of the present disclosure. The image forming apparatus 1000 is a printer. Alternatively, the image forming apparatus 1000 may be a copier, a facsimile machine, a printing machine, a multifunction peripheral (MFP) having at least two of printing, copying, facsimile, scanning, and plotter functions, or the like. Image formation described below denotes forming an image having meaning such as characters and figures and an image not having meaning such as patterns.

Referring to FIG. 1, a description is provided of the overall construction and operation of the image forming apparatus 1000 according to the embodiment of the present disclosure.

As illustrated in FIG. 1, the image forming apparatus 1000 according to the embodiment of the present disclosure includes an apparatus body 103 that accommodates an image forming portion 100, a fixing portion 200, a sheet supply portion 300, and a sheet ejecting portion 400.

A description is provided of a construction of the image forming portion 100.

The image forming portion 100 forms a toner image on a sheet P serving as a recording medium. The image forming portion 100 includes four image forming units 1Y, 1M, 1C, and 1Bk, an exposure device 6, and a transfer device 8.

Each of the four image forming units 1Y, 1M, 1C, and 1Bk, serving as an image forming device, includes an electrostatic latent image bearer 2, a charger 3, a developing device 4, and a cleaner 5.

The electrostatic latent image bearer 2 serves as a rotator that bears an electrostatic latent image on a surface of the electrostatic latent image bearer 2. For example, the electrostatic latent image bearer 2 is a photoconductive drum, an endless photoconductive belt, or the like.

The charger 3 charges the surface of the electrostatic latent image bearer 2. Types of the charger 3 are not limited and are selected properly depending on an objective as long as the charger 3 applies a voltage onto the surface of the electrostatic latent image bearer 2, thus uniformly charging the surface of the electrostatic latent image bearer 2. For example, the charger 3 is a contact type charger such as a conductive or semiconductive charging roller, a magnetic brush, a fur brush, film, and a rubber blade or a non-contact type charger using corona discharge.

The developing device 4 supplies toner serving as a developer to the electrostatic latent image formed on the electrostatic latent image bearer 2 to form a toner image. The developing devices 4 of the image forming units 1Y, 1M, 1C, and 1Bk contain toners, serving as developers, in different colors, that is, yellow, magenta, cyan, and black, respectively, that correspond to color separation components for a color image.

The cleaner 5 removes residual toner and other foreign substance that remain on the electrostatic latent image bearer 2 therefrom. The cleaner 5 includes a cleaning blade or the like that contacts the surface of the electrostatic latent image bearer 2.

The exposure device 6 exposes the charged surface of each of the electrostatic latent image bearers 2 and forms an electrostatic latent image thereon. Types of the exposure device 6 are not limited and are selected properly depending on an objective as long as the exposure device 6 exposes the charged surface of each of the electrostatic latent image bearers 2. For example, the exposure device 6 employs a duplication optical system, a rod lens array system, a laser optical system, a liquid crystal shutter optical system, a light-emitting diode (LED) optical system, or the like.

The image forming apparatus 1000 further includes toner bottles 90Y, 90M, 90C, and 90Bk that contain fresh yellow, magenta, cyan, and black toners, respectively, and are removably disposed in an upper portion of the image forming apparatus 1000. The toner bottles 90Y, 90M, 90C, and 90Bk supply the fresh yellow, magenta, cyan, and black toners to the developing devices 4 through toner supply tubes interposed between the toner bottles 90Y, 90M, 90C, and 90Bk and the developing devices 4, respectively.

The transfer device 8 transfers the toner image onto a sheet P. The transfer device 8 includes an intermediate transfer belt 11, four primary transfer rollers 12, and a secondary transfer roller 13. The intermediate transfer belt 11 is an endless belt that is stretched across a plurality of support rollers. The four primary transfer rollers 12 are disposed within a loop formed by the intermediate transfer belt 11. The primary transfer rollers 12 press against the electrostatic latent image bearers 2, respectively, via the intermediate transfer belt 11, thus forming primary transfer nips between the intermediate transfer belt 11 and the electrostatic latent image bearers 2. The secondary transfer roller 13 contacts an outer circumferential face of the intermediate transfer belt 11, forming a secondary transfer nip between the secondary transfer roller 13 and the intermediate transfer belt 11.

The intermediate transfer belt 11 may have a single-layer structure or a multilayer structure. In a case that the intermediate transfer belt 11 has the single-layer structure, the intermediate transfer belt 11 is preferably made of polyvinylidene fluoride, polycarbonate, polyimide, or the like. In a case that the intermediate transfer belt 11 has the multilayer structure, the intermediate transfer belt 11 includes a base layer and a coating layer. The base layer is made of a stretch resistant material such as fluororesin, a polyvinylidene fluoride sheet, and polyimide resin. The coating layer serves as a surface layer that has an enhanced smoothness and is made of fluororesin or the like.

A description is provided of a construction of the fixing portion 200.

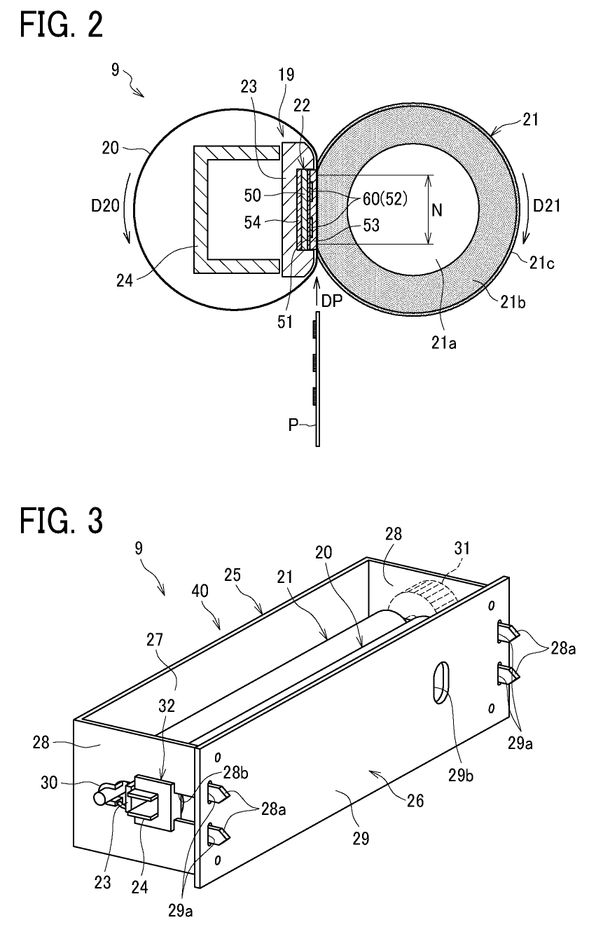

The fixing portion 200 includes a fixing device 9 that heats the sheet P, fixing the toner image on the sheet P. The fixing device 9 includes a pair of rotators, that is, a fixing belt 20 and a pressure roller 21 that contacts the fixing belt 20. The fixing device 9 further includes a heater 22 depicted in FIG. 2, that heats at least one of the fixing belt 20 or the pressure roller 21.

A description is provided of a construction of the sheet supply portion 300.

The sheet supply portion 300 supplies the sheet P to the image forming portion 100. The sheet supply portion 300 includes a sheet tray 14 and a feed roller 15. The sheet tray 14 loads a plurality of sheets P. The feed roller 15 picks up and feeds a sheet P from the sheet tray 14. The image forming apparatus 1000 further includes a timing roller pair 16 that is interposed between the feed roller 15 and the secondary transfer roller 13. For example, in addition to paper, the sheets P include an overhead projector (OHP) transparency, cloth, a metal sheet, plastic film, and a prepreg sheet pre-impregnated with resin in carbon fibers. In addition to plain paper, the sheets P include thick paper, a postcard, an envelope, thin paper, coated paper, art paper, and tracing paper.

A description is provided of a construction of the sheet ejecting portion 400.

The sheet ejecting portion 400 ejects the sheet P onto an outside of the image forming apparatus 1000. The sheet ejecting portion 400 includes an output roller pair 17 and an output tray 18. The output roller pair 17 ejects the sheet P onto the output tray 18. The output tray 18 is placed with the sheet P ejected by the output roller pair 17.

Referring to FIG. 1, a description is provided of image forming processes performed by the image forming apparatus 1000 according to the embodiment of the present disclosure.

As the image forming apparatus 1000 receives an instruction from a control panel or an external terminal and starts a print job, a driver starts rotating the electrostatic latent image bearer 2 of each of the image forming units 1Y, 1M, 1C, and 1Bk clockwise in FIG. 1.

Subsequently, the charger 3 uniformly charges the surface of the electrostatic latent image bearer 2 at a high electric potential. The exposure device 6 exposes the charged surfaces of the electrostatic latent image bearers 2, respectively, according to image data (e.g., print data) sent from the external terminal. Alternatively, if the image forming apparatus 1000 is a copier, the exposure device 6 exposes the charged surfaces of the electrostatic latent image bearers 2, respectively, according to image data created by a scanner that reads an image on an original. Accordingly, the electric potential of an exposed portion on the surface of each of the electrostatic latent image bearers 2 decreases, forming an electrostatic latent image on the surface of each of the electrostatic latent image bearers 2. Thereafter, the developing devices 4 supply toner to the electrostatic latent images formed on the electrostatic latent image bearers 2, respectively, thus forming toner images in different colors, that is, yellow, magenta, cyan, and black toner images, on the electrostatic latent image bearers 2.

The toner images formed on the electrostatic latent image bearers 2 travel and reach the primary transfer nips defined by the primary transfer rollers 12 in accordance with rotation of the electrostatic latent image bearers 2, respectively. The primary transfer rollers 12 transfer the toner images formed on the electrostatic latent image bearers 2 onto the intermediate transfer belt 11 driven and rotated counterclockwise in FIG. 1 successively at the primary transfer nips such that the toner images are superimposed on the intermediate transfer belt 11. Thus, the superimposed toner images form a full color toner image on the intermediate transfer belt 11. The four image forming units 1Y, 1M, 1C, and 1Bk form the full color toner image. Alternatively, one of the four image forming units 1Y, 1M, 1C, and 1Bk may be used to form a monochrome toner image or two or three of the four image forming units 1Y, 1M, 1C, and 1Bk may be used to form a bicolor toner image or a tricolor toner image. After the primary transfer roller 12 transfers the toner image formed on the electrostatic latent image bearer 2 onto the intermediate transfer belt 11, the cleaner 5 cleans the electrostatic latent image bearer 2. For example, the cleaner 5 removes a foreign substance such as residual toner from the surface of the electrostatic latent image bearer 2.

The full color toner image formed on the intermediate transfer belt 11 is conveyed to the secondary transfer nip defined by the secondary transfer roller 13 in accordance with rotation of the intermediate transfer belt 11. The secondary transfer roller 13 transfers the full color toner image formed on the intermediate transfer belt 11 onto a sheet P at the secondary transfer nip. The sheet P is supplied from the sheet supply portion 300. After the image forming apparatus 1000 starts the print job, the feed roller 15 rotates to pick up and feed the sheet P from the sheet tray 14. As the sheet P fed by the feed roller 15 comes into contact with the timing roller pair 16 before the sheet P reaches the secondary transfer nip, the timing roller pair 16 temporarily interrupts conveyance of the sheet P. Thereafter, the timing roller pair 16 resumes rotation at a predetermined time, conveying the sheet P to the secondary transfer nip at a proper time when the full color toner image formed on the intermediate transfer belt 11 reaches the secondary transfer nip. The secondary transfer roller 13 transfers the full color toner image onto the sheet P.

The sheet P transferred with the full color toner image is conveyed to the fixing portion 200. In the fixing portion 200, as the sheet P bearing the full color toner image is conveyed through a fixing nip formed between the fixing belt 20 and the pressure roller 21, the fixing belt 20 and the pressure roller 21 fix the full color toner image on the sheet P under heat and pressure. Thereafter, the sheet P is conveyed to the sheet ejecting portion 400 where the output roller pair 17 ejects the sheet P onto the output tray 18. Thus, a series of image forming processes finishes.

A description is provided of a construction of the fixing device 9.

As illustrated in FIG. 2, the fixing device 9 according to the embodiment includes a heating device 19 and the pressure roller 21. The heating device 19 includes the fixing belt 20, the heater 22, a heater holder 23, and a stay 24. The fixing belt 20 is an endless belt. The fixing belt 20 rotates in a rotation direction D20. The pressure roller 21 serves as an opposed rotator or a pressure rotator. The heater 22 heats the fixing belt 20. The heater 22 is a laminated heater that serves as a heater or a heating body. The heater holder 23 serves as a holder that holds or supports the heater 22. The stay 24 serves as a reinforcement. The pressure roller 21 contacts an outer circumferential face of the fixing belt 20 to form a fixing nip N serving as a nip between the fixing belt 20 and the pressure roller 21. The pressure roller 21 rotates in a rotation direction D21. The stay 24 reinforces the heater holder 23 throughout an entire span of the heater holder 23 in a longitudinal direction thereof. According to the embodiment, the fixing belt 20 serves as a heated member or a rotator that is heated by the heater 22. The fixing device 9 is installed with a fixing rotator as an embodiment of the rotator. The fixing belt 20 according to the embodiment is one example of the fixing rotator.

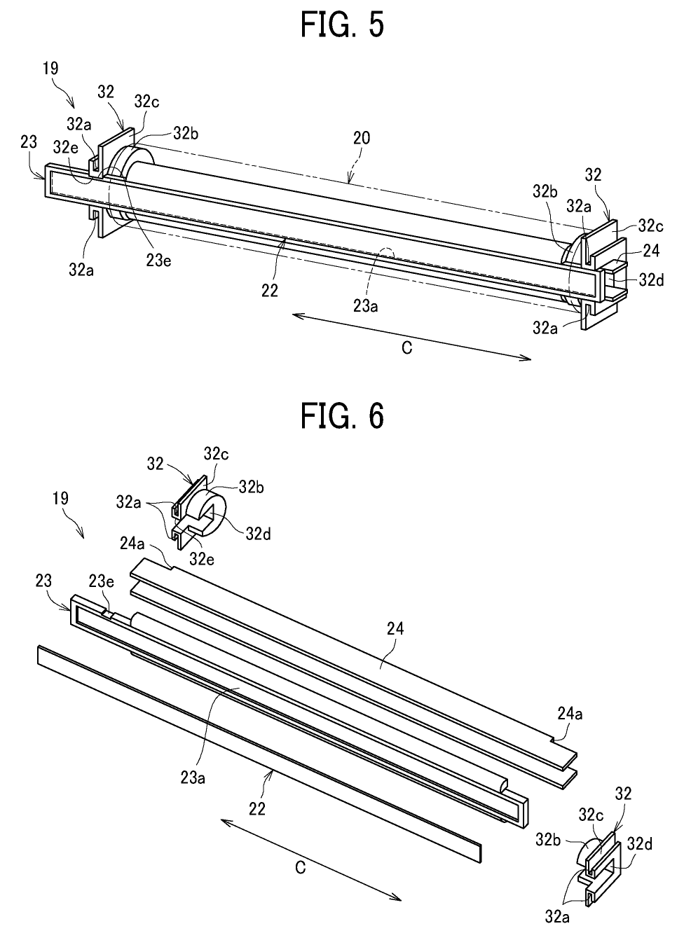

The fixing belt 20, the pressure roller 21, the heater 22, the heater holder 23, and the stay 24 extend in a direction that is perpendicular to a paper surface in FIG. 2 and is a longitudinal direction (e.g., a longitudinal direction C of the heater 22 depicted in FIG. 5) of the fixing belt 20, the pressure roller 21, the heater 22, the heater holder 23, and the stay 24. The longitudinal direction is equivalent to an axial direction of the fixing belt 20 and the pressure roller 21. The sheet P is conveyed in a sheet conveyance direction DP that is parallel to a vertical direction in FIG. 2. The pressure roller 21 applies pressure to the fixing belt 20 in a pressing direction that is parallel to a horizontal direction in FIG. 2.

The fixing belt 20 includes a tubular base layer that is made of polyimide (PI) and has an outer diameter of 25 mm and a thickness in a range of from 40 µm to 120 µm, for example. The fixing belt 20 further includes a release layer serving as an outermost surface layer. The release layer is made of fluororesin, such as perfluoroalkoxy alkane (PFA) and polytetrafluoroethylene (PTFE), and has a thickness in a range of from 5 µm to 50 µm to enhance durability of the fixing belt 20 and facilitate separation of the sheet P from the fixing belt 20. Optionally, an elastic layer that is made of rubber or the like and has a thickness in a range of from 50 µm to 500 µm may be interposed between the base layer and the release layer. The base layer of the fixing belt 20 may be made of heat-resistant resin such as polyether ether ketone (PEEK) or metal such as nickel (Ni) and stainless used steel (SUS), instead of polyimide. An inner circumferential face of the fixing belt 20 may be coated with polyimide, PTFE, or the like to produce a sliding layer.

The pressure roller 21 has an outer diameter of 25 mm, for example. The pressure roller 21 includes a core metal 21a, an elastic layer 21b disposed on a surface of the core metal 21a, and a release layer 21c disposed on an outer surface of the elastic layer 21b. The core metal 21a is solid and made of iron. The elastic layer 21b is made of silicone rubber and has a thickness of 3.5 mm, for example. In order to enhance separation of the sheet P from the pressure roller 21, the elastic layer 21b is preferably coated with the release layer 21c that is made of fluororesin and has a thickness of approximately 40 µm, for example.

The heater 22 extends in the longitudinal direction thereof throughout an entire span of the fixing belt 20 in a width direction, that is, the axial direction, of the fixing belt 20. The heater 22 contacts the inner circumferential face of the fixing belt 20. The heater 22 may not contact the fixing belt 20 or may be disposed opposite the fixing belt 20 indirectly via a low-friction sheet or the like. However, the heater 22 that contacts the fixing belt 20 directly enhances conduction of heat from the heater 22 to the fixing belt 20. The heater 22 may contact the outer circumferential face of the fixing belt 20. However, if the outer circumferential face of the fixing belt 20 is brought into contact with the heater 22 and damaged, the fixing belt 20 may degrade quality of fixing the toner image on the sheet P. Hence, the heater 22 contacts the inner circumferential face of the fixing belt 20 advantageously. The heater 22 includes a base layer 50, a first insulating layer 51, a conductor layer 52, a second insulating layer 53, and a third insulating layer 54. The first insulating layer 51, the conductor layer 52, and the second insulating layer 53 are layered on the base layer 50 in order and sandwiched between the base layer 50 and the fixing nip N. The conductor layer 52 includes a resistive heat generator 60. The third insulating layer 54 is layered on the base layer 50 and is disposed opposite the fixing nip N via the base layer 50.

The heater holder 23 and the stay 24 are disposed within a loop formed by the fixing belt 20. The stay 24 includes a channel made of metal. Both lateral ends of the stay 24 in the longitudinal direction thereof are supported by side walls (e.g., side plates) of the fixing device 9, respectively. The stay 24 supports a stay side face of the heater holder 23, that faces the stay 24 and is opposite to a heater side face of the heater holder 23, that faces the heater 22. Accordingly, the stay 24 retains the heater 22 and the heater holder 23 to be immune from being bent substantially by pressure from the pressure roller 21, forming the fixing nip N between the fixing belt 20 and the pressure roller 21. According to the embodiment, the heater 22 and the pressure roller 21 sandwich the fixing belt 20. Thus, the heater 22 serves as a nip formation pad that forms the fixing nip N between the fixing belt 20 and the pressure roller 21. Hence, the heater 22 downsizes the fixing device 9 compared to a construction described below with reference to FIG. 16, in which the heater 22 is provided separately from a nip formation pad 91.

Since the heater holder 23 is subject to high temperatures by heat from the heater 22, the heater holder 23 is preferably made of a heat-resistant material. For example, in a case that the heater holder 23 is made of heat-resistant resin having a decreased thermal conductivity, such as liquid crystal polymer (LCP) and PEEK, the heater holder 23 suppresses conduction of heat thereto from the heater 22, facilitating heating of the fixing belt 20.

The fixing device 9 further includes a spring serving as a biasing member that causes the fixing belt 20 and the pressure roller 21 to press against each other. Thus, the fixing nip N is formed between the fixing belt 20 and the pressure roller 21. As a driver disposed inside the apparatus body 103 of the image forming apparatus 1000 transmits a driving force to the pressure roller 21, the pressure roller 21 serves as a driving roller that drives and rotates the fixing belt 20. As the pressure roller 21 rotates, the pressure roller 21 drives and rotates the fixing belt 20. While the fixing belt 20 rotates, the fixing belt 20 slides over the heater 22. In order to facilitate sliding of the fixing belt 20, a lubricant such as oil and grease may be interposed between the heater 22 and the fixing belt 20.

When printing starts, the driver drives and rotates the pressure roller 21 and the fixing belt 20 starts rotation in accordance with rotation of the pressure roller 21. Additionally, as power is supplied to the heater 22, the heater 22 heats the fixing belt 20. In a state in which the temperature of the fixing belt 20 reaches a predetermined target temperature (e.g., a fixing temperature), as a sheet P bearing an unfixed toner image is conveyed through the fixing nip N formed between the fixing belt 20 and the pressure roller 21 in the sheet conveyance direction DP as illustrated in FIG. 2, the fixing belt 20 and the pressure roller 21 fix the unfixed toner image on the sheet P under heat and pressure.

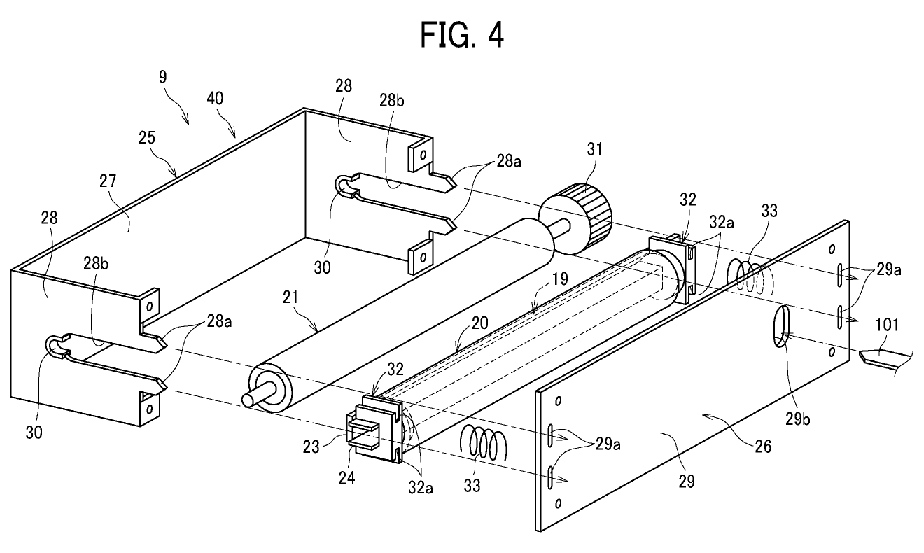

FIG. 3 is a perspective view of the fixing device 9. FIG. 4 is an exploded perspective view of the fixing device 9.

As illustrated in FIGS. 3 and 4, the fixing device 9 includes a device frame 40 that includes a first device frame 25 and a second device frame 26. The first device frame 25 includes a pair of side walls 28 and a front wall 27. The second device frame 26 includes a rear wall 29. The side walls 28 are disposed opposite one lateral end and another lateral end of the fixing belt 20, respectively, in the width direction of the fixing belt 20. The side walls 28 support both lateral ends of each of the pressure roller 21 and the heating device 19, respectively, in the longitudinal direction thereof. Each of the side walls 28 includes a plurality of engaging projections 28a. The second device frame 26 further includes coupling holes 29a that penetrate through the rear wall 29. As the engaging projections 28a engage the coupling holes 29a, respectively, the first device frame 25 is coupled with the second device frame 26.

Each of the side walls 28 includes an insertion recess 28b through which a rotation shaft of the pressure roller 21 and the like are inserted. The insertion recess 28b is open at an opening that faces the rear wall 29 and closed at a bottom that is opposite to the opening and serves as a contact portion. The first device frame 25 further includes bearings 30 that support the rotation shaft of the pressure roller 21. Each of the bearings 30 is disposed at an end of the insertion recess 28b, that serves as the contact portion. As both lateral ends of the rotation shaft of the pressure roller 21 in the axial direction thereof are attached to the bearings 30, respectively, the side walls 28 rotatably support the pressure roller 21.

The fixing device 9 further includes a driving force transmission gear 31 serving as a driving force transmitter that is mounted on one lateral end of the rotation shaft of the pressure roller 21 in the axial direction thereof. In a state in which the side walls 28 support the pressure roller 21, the driving force transmission gear 31 is exposed outside the side wall 28. Accordingly, when the fixing device 9 is installed in the apparatus body 103 of the image forming apparatus 1000, the driving force transmission gear 31 is coupled with a gear disposed inside the apparatus body 103 of the image forming apparatus 1000 so that the driving force transmission gear 31 transmits the driving force from the driver. Alternatively, a driving force transmitter that transmits the driving force to the pressure roller 21 may be pulleys over which a driving force transmission belt is stretched, a coupler, or the like instead of the driving force transmission gear 31.

The heating device 19 further includes a pair of supports 32 that supports the fixing belt 20 and the like. The supports 32 are disposed at both lateral ends of the heating device 19 in a longitudinal direction thereof, respectively. Each of the supports 32 is a device frame of the heating device 19 and a part of the device frame 40 of the fixing device 9. The supports 32 support the fixing belt 20 in a state in which the fixing belt 20 is not basically applied with tension in a circumferential direction thereof while the fixing belt 20 does not rotate, that is, by a free belt system. Each of the supports 32 includes guide grooves 32a. As the guide grooves 32a move along edges of the insertion recess 28b of the side wall 28, respectively, the support 32 is attached to the side wall 28.

The fixing device 9 further includes a pair of springs 33 serving as a pair of biasing members that is interposed between the supports 32 and the rear wall 29, respectively. As the springs 33 bias the stay 24 and the supports 32 toward the pressure roller 21, respectively, the fixing belt 20 is pressed against the pressure roller 21 to form the fixing nip N between the fixing belt 20 and the pressure roller 21.

As illustrated in FIG. 4, the rear wall 29 constructing the second device frame 26 includes a through hole 29b that is disposed at one lateral end of the rear wall 29 in a longitudinal direction of the second device frame 26. The through hole 29b serves as a positioner that positions a body of the fixing device 9 with respect to the apparatus body 103 of the image forming apparatus 1000. The image forming apparatus 1000 further includes a projection 101 that is disposed inside the apparatus body 103. When the body of the fixing device 9 is installed in the apparatus body 103 of the image forming apparatus 1000, the projection 101 serving as a positioner disposed inside the apparatus body 103 of the image forming apparatus 1000 is inserted into the through hole 29b of the fixing device 9. Accordingly, the projection 101 engages the through hole 29b, positioning the body of the fixing device 9 with respect to the apparatus body 103 of the image forming apparatus 1000 in a longitudinal direction of the fixing device 9, that is, the width direction or the axial direction of the fixing belt 20. Although the through hole 29b serving as a positioner is disposed at one lateral end of the rear wall 29 in the longitudinal direction of the second device frame 26, another positioner is not disposed at another lateral end of the rear wall 29 in the longitudinal direction of the second device frame 26. Thus, the second device frame 26 does not restrict thermal expansion and shrinkage of the body of the fixing device 9 in the longitudinal direction thereof due to temperature change.

FIG. 5 is a perspective view of the heating device 19. FIG. 6 is an exploded perspective view of the heating device 19.

As illustrated in FIGS. 5 and 6, the heater holder 23 includes an accommodating recess 23a that is disposed on a belt side face of the heater holder 23, that faces the fixing belt 20 and the fixing nip N. The accommodating recess 23a is rectangular and accommodates the heater 22. The heating device 19 further includes a connector described below that sandwiches the heater 22 and the heater holder 23 in a state in which the accommodating recess 23a accommodates the heater 22. Thus, the heater holder 23 holds the heater 22.

Each of the pair of supports 32 includes a belt support 32b, a belt restrictor 32c, and a supporting recess 32d. The belt support 32b is C-shaped and inserted into the loop formed by the fixing belt 20, thus contacting the inner circumferential face of the fixing belt 20 to support the fixing belt 20. The belt restrictor 32c is a flange that contacts an edge face of the fixing belt 20 to restrict motion (e.g., skew) of the fixing belt 20 in the width direction thereof. The supporting recess 32d is inserted with a lateral end of each of the heater holder 23 and the stay 24 in the longitudinal direction C of the heater 22, thus supporting the heater holder 23 and the stay 24.

As illustrated in FIGS. 5 and 6, the heater holder 23 further includes a positioning recess 23e, serving as a positioner, that is disposed at one lateral end of the heater holder 23 in the longitudinal direction thereof. The support 32 further includes an engagement 32e illustrated in a left part in FIGS. 5 and 6. The engagement 32e engages the positioning recess 23e, positioning the heater holder 23 with respect to the support 32 in the longitudinal direction of the heater holder 23. The support 32 illustrated in a right part in FIGS. 5 and 6 does not include the engagement 32e and therefore the heater holder 23 is not positioned with respect to the support 32 in the longitudinal direction of the heater holder 23. Thus, the support 32 does not restrict thermal expansion and shrinkage of the heater holder 23 in the longitudinal direction thereof due to temperature change.

As illustrated in FIG. 4, as the guide grooves 32a of the support 32 move along the insertion recess 28b of the side wall 28, the support 32 is attached to the side wall 28 disposed at each lateral end of the first device frame 25 in a longitudinal direction thereof. The support 32, situated at a rear position in FIG. 4, of the two supports 32 depicted in FIG. 4 positions the heater holder 23 in the longitudinal direction thereof. As the support 32 situated at the rear position in FIG. 4 is attached to the side wall 28, the heater holder 23 is positioned with respect to the side wall 28 in the longitudinal direction of the heater holder 23. Thus, the side wall 28 and the support 32 serve as positioners that position the heater holder 23 with respect to the body of the fixing device 9 in the longitudinal direction of the heater holder 23.

The stay 24 is not positioned with respect to the support 32 in the longitudinal direction of the stay 24. As illustrated in FIG. 6, the stay 24 includes steps 24a that are disposed at both lateral ends of the stay 24 in the longitudinal direction thereof, respectively. The steps 24a restrict motion (e.g., dropping) of the stay 24 with respect to the supports 32, respectively, in the longitudinal direction of the stay 24. A clearance is provided between the step 24a and at least one of the supports 32 in the longitudinal direction of the stay 24. For example, the stay 24 is attached to the supports 32 such that loose fit with play is provided between the stay 24 and each of the supports 32 in the longitudinal direction of the stay 24 so that the supports 32 do not restrict thermal expansion and shrinkage of the stay 24 in the longitudinal direction thereof due to temperature change. That is, the stay 24 is not positioned with respect to one of the supports 32.

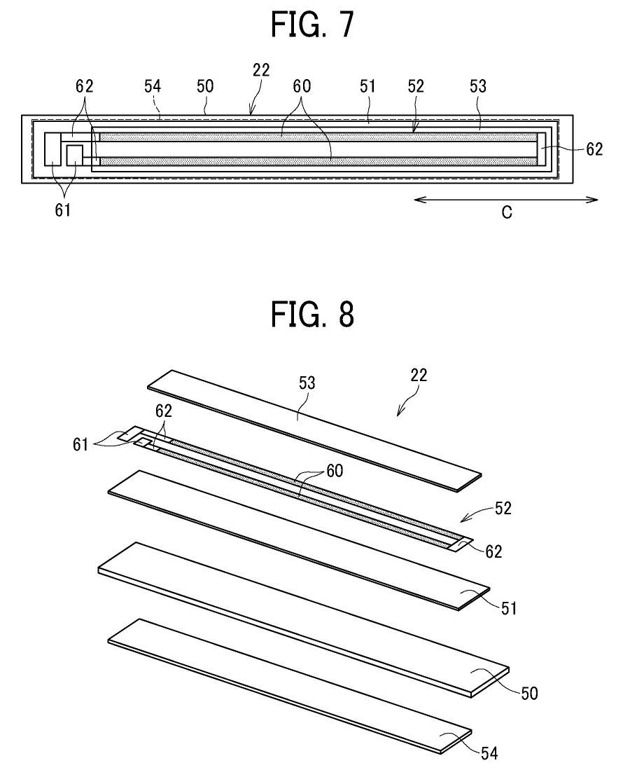

FIG. 7 is a plan view of the heater 22. FIG. 8 is an exploded perspective view of the heater 22. Hereinafter, a front side of the heater 22 defines a side that faces the fixing belt 20 and the fixing nip N. A back side of the heater 22 defines a side that faces the heater holder 23.

As illustrated in FIGS. 7 and 8, the heater 22 includes a plurality of layers, that is, the base layer 50, the first insulating layer 51, the conductor layer 52, the second insulating layer 53, and the third insulating layer 54. The base layer 50 is platy. The first insulating layer 51 is mounted on the front side of the base layer 50. The conductor layer 52 is mounted on the front side of the first insulating layer 51. The second insulating layer 53 coats the front side of the conductor layer 52. The third insulating layer 54 is mounted on the back side of the base layer 50. The conductor layer 52 includes the resistive heat generators 60, a pair of electrodes 61, and a plurality of feeders 62. Each of the resistive heat generators 60 is a laminated, resistive heat generator. Each of the electrodes 61 is coupled with one lateral end of each of the resistive heat generators 60 in the longitudinal direction C of the heater 22 through the feeder 62. The plurality of feeders 62 includes feeders, each of which couples the electrode 61 with the resistive heat generator 60, and a feeder that couples the resistive heat generators 60. As illustrated in FIG. 7, at least a part of each of the electrodes 61 is not coated with the second insulating layer 53 and is exposed so that the electrodes 61 are connected to the connector described below.

For example, each of the resistive heat generators 60 is produced as below. Silver-palladium (AgPd), glass powder, and the like are mixed into paste. The paste coats the base layer 50 by screen printing or the like. Thereafter, the base layer 50 is subject to firing. Alternatively, the resistive heat generator 60 may be made of a resistive material such as a silver alloy (AgPt) and ruthenium oxide (RuO ₂). According to the embodiment, the resistive heat generators 60 are parallel to each other and extended in a longitudinal direction of the base layer 50. One end (e.g., a right end in FIG. 7) of one of the resistive heat generators 60 is electrically connected to one end of another one of the resistive heat generators 60 through the feeder 62. Another end (e.g., a left end in FIG. 7) of each of the resistive heat generators 60 is electrically connected to the electrode 61 through another feeder 62. The feeders 62 are made of a conductor having a resistance value smaller than a resistance value of the resistive heat generators 60. The feeders 62 and the electrodes 61 are made of a material prepared with silver (Ag), silver-palladium (AgPd), or the like by screen printing or the like.

The base layer 50 is made of a metal material such as stainless steel (e.g., SUS), iron, and aluminum. Instead of the metal material, the base layer 50 may be made of ceramic, glass, or the like. In a case that the base layer 50 is made of an insulating material such as ceramic, the first insulating layer 51 sandwiched between the base layer 50 and the conductor layer 52 may be omitted. Since the metal material has an enhanced durability against rapid heating and is machined readily, the metal material is preferably used to reduce manufacturing costs. Among metals, aluminum and copper are preferable because aluminum and copper attain an increased thermal conductivity and barely suffer from uneven temperature. Stainless steel is advantageous because stainless steel is manufactured at reduced costs compared to aluminum and copper.

Each of the first insulating layer 51, the second insulating layer 53, and the third insulating layer 54 is made of heat-resistant glass. Alternatively, each of the first insulating layer 51, the second insulating layer 53, and the third insulating layer 54 may be made of ceramic, PI, or the like.

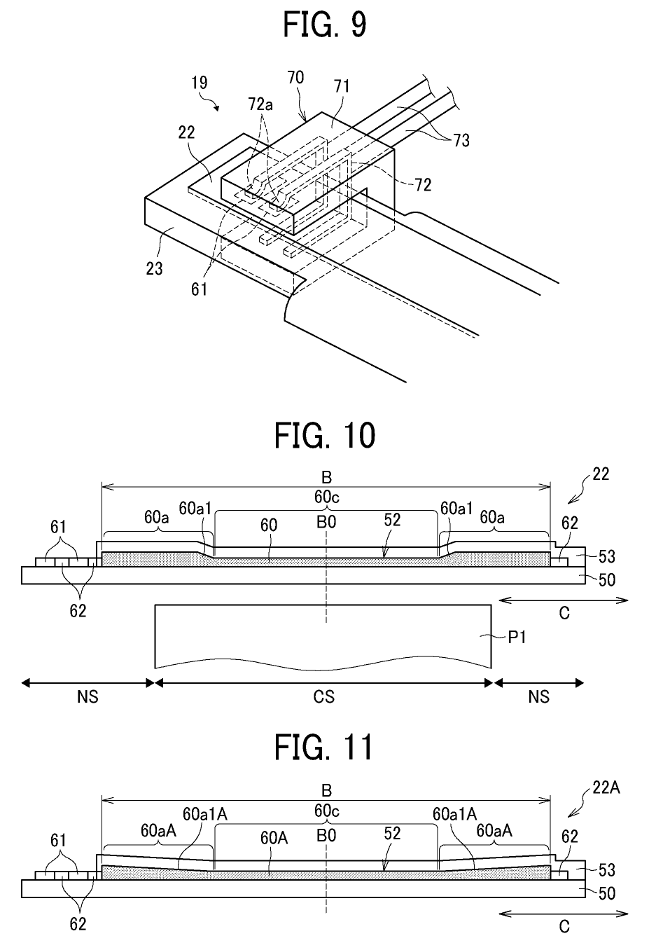

FIG. 9 is a perspective view of the heater 22 and the heater holder 23, illustrating a connector 70 attached thereto. The connector 70 serves as a feeding member.

As illustrated in FIG. 9, the connector 70 includes a housing 71 made of resin and contact terminals 72 secured to the housing 71. Each of the contact terminals 72 is a flat spring. The contact terminals 72 include a pair of contacts 72a that contacts the electrodes 61 of the heater 22, respectively. The heating device 19 further includes harnesses 73 with which the contact terminals 72 of the connector 70 are coupled, respectively. The harnesses 73 supply power to the connector 70.

As illustrated in FIG. 9, the connector 70 is attached to the heater 22 and the heater holder 23 such that the connector 70 sandwiches the heater 22 and the heater holder 23 together at the front side of the heater 22 and the back side of the heater holder 23, respectively. Accordingly, the contacts 72a of the contact terminals 72 resiliently contact or press against the electrodes 61 of the heater 22, respectively. Consequently, the resistive heat generators 60 are electrically connected to a power supply disposed in the image forming apparatus 1000 through the connector 70, allowing the power supply to supply power to the resistive heat generators 60.

With the above-described construction of the fixing device 9, in a case that a plurality of sheets P having a decreased size is conveyed over the fixing belt 20 continuously, for example, both lateral end spans of the fixing belt 20 in the longitudinal direction thereof, where the sheets P are not conveyed, may suffer from overheating, causing a disadvantage of temperature increase of both lateral end spans of the fixing belt 20 in the longitudinal direction thereof. For example, as the sheets P having the decreased size are conveyed over the fixing belt 20 continuously, non-conveyance spans where the sheets P are not conveyed are formed in both lateral end spans of the fixing belt 20 in the longitudinal direction thereof, respectively. The sheets P do not draw heat from the fixing belt 20 in the non-conveyance spans. Hence, as the sheets P having the decreased size are conveyed through the fixing device 9 continuously, both lateral end spans of the fixing belt 20 in the longitudinal direction thereof may overheat.

A description is provided of a construction of a comparative fixing device.

The comparative fixing device includes a heated member (e.g., a fixing film) and a heater. The heater includes a base layer and a resistive heat generator. To address temperature increase of the heated member in both lateral end spans in a longitudinal direction of the heated member, a width of the resistive heat generator in a short direction thereof in each of both lateral end portions of the resistive heat generator in a longitudinal direction thereof is greater than a width of the resistive heat generator in the short direction thereof in a center portion of the resistive heat generator in the longitudinal direction thereof. Thus, the comparative fixing device decreases a heat generation amount of the resistive heat generator in both lateral end portions in the longitudinal direction thereof.

The resistive heat generator is mounted on the base layer with a distance from a lateral edge of the base layer. With a configuration in which a plurality of resistive heat generators is mounted on the base layer, the adjacent resistive heat generators are arranged with a predetermined clearance therebetween. Thus, the resistive heat generator is mounted on the base layer with restrictions.

Hence, as the width of the resistive heat generator in the short direction thereof increases, the base layer may have an increased area, upsizing the comparative fixing device and increasing costs. Accordingly, the comparative fixing device having the above-described construction that suppresses temperature increase of the heated member in both lateral end spans in the longitudinal direction of the heated member may be disadvantageous.

Referring to FIG. 10, a description is provided of a construction of the heater 22 according to an embodiment of the present disclosure, that suppresses temperature increase of the fixing belt 20 in both lateral end spans in the longitudinal direction thereof.

FIG. 10 is a side cross-sectional view of the heater 22. FIG. 10 omits illustration of the first insulating layer 51 and the third insulating layer 54.

As illustrated in FIG. 10, the heater 22 according to the embodiment includes the resistive heat generator 60 that includes both lateral end portions and a center portion in the longitudinal direction C of the heater 22. A thickness (e.g., a vertical width in FIG. 10) of each of the lateral end portions is greater than a thickness of the center portion. For example, the resistive heat generator 60 extends in a heat generation span B in the longitudinal direction of the heater 22. The heat generation span B is divided into three equal parts in the longitudinal direction C of the heater 22, that define the lateral end portion, the center portion, and the lateral end portion of the resistive heat generator 60 in the longitudinal direction C of the heater 22.

According to the embodiment, the resistive heat generator 60 includes a body 60c and projections 60a projecting beyond the body 60c. Each of the projections 60a, serving as the lateral end portion, has a thickness that is greater than a thickness of the body 60c serving as the center portion. Each of the projections 60a includes a slope 60a1 from which the projection 60a extends to a lateral edge of the heat generation span B in the longitudinal direction C of the heater 22. The slope 60a1 has a thickness that increases gradually from an inboard end of the slope 60a1, that abuts on the body 60c serving as the center portion of the resistive heat generator 60, toward an outboard end of the slope 60a1, that is disposed closer to a lateral edge of the resistive heat generator 60 than the inboard end is, in the longitudinal direction C of the heater 22. FIG. 10 illustrates a small sheet P1 having a decreased size. According to the embodiment, sheets P having a plurality of sizes are conveyed in a state in which the sheets P are centered at a center position (e.g., a center position B0 of the heat generation span B) in a width direction of the sheets P. In a case that the small sheet P1 is conveyed, the small sheet P1 forms non-conveyance spans NS that are disposed outboard from the small sheet P1 and disposed in both lateral end spans of the fixing belt 20 in the longitudinal direction thereof, respectively. According to the embodiment, an increased thickness span (e.g., the projection 60a) disposed in the lateral end portion of the resistive heat generator 60 in a longitudinal direction thereof partially overlaps a conveyance span CS where the small sheet P1 is conveyed. The width direction of the sheets P and P1 is perpendicular to the sheet conveyance direction DP depicted in FIG. 2 and is parallel to the longitudinal direction C of the heater 22 and the like.

According to the embodiment, the resistive heat generators 60 extend in the longitudinal direction thereof. An electric current flows within the resistive heat generators 60 in the longitudinal direction thereof. The resistive heat generators 60 are connected in series. The center portion and the lateral end portions of the resistive heat generator 60 in the longitudinal direction thereof form a series circuit. As described above, both lateral end portions (e.g., the projections 60a) of the resistive heat generator 60 in the longitudinal direction thereof have an increased thickness, thus attaining a decreased resistance value and a decreased heat generation amount. For example, a heat generation amount per unit length of each of the lateral end portions (e.g., the projections 60a) of the resistive heat generator 60 is smaller than a heat generation amount per unit length of the center portion (e.g., the body 60c) of the resistive heat generator 60 in the longitudinal direction thereof. Accordingly, even in a case that a plurality of sheets P1 is conveyed continuously, the resistive heat generator 60 suppresses temperature increase of both lateral end spans (e.g., the non-conveyance spans NS) of the fixing belt 20 in the longitudinal direction thereof.

Each of the lateral end portions of the resistive heat generator 60 in the longitudinal direction thereof may have an increased width in a short direction of the resistive heat generator 60, thus attaining a decreased resistance value and a decreased heat generation amount. However, the resistive heat generator 60 may be mounted on the base layer 50 with a distance from a lateral edge of the base layer 50 and the adjacent resistive heat generators 60 may be arranged with a predetermined clearance therebetween. Thus, the resistive heat generator 60 may be mounted on the base layer 50 with restrictions. Hence, as the width of the resistive heat generator 60 in the short direction thereof increases, the base layer 50 may have an increased area, upsizing the fixing device 9 and increasing costs. To address the circumstance, the resistive heat generator 60 according to the embodiment has the increased thickness. Thus, the resistive heat generator 60 suppresses temperature increase of the fixing belt 20 in the lateral end spans in the longitudinal direction thereof without increasing an area of a mount face of the base layer 50, that mounts the resistive heat generator 60. Accordingly, the resistive heat generator 60 suppresses temperature increase of the fixing belt 20 in the lateral end spans in the longitudinal direction thereof while suppressing upsizing of the fixing device 9 and increase in costs.

In the fixing device 9 according to the embodiment, in order to decrease sliding friction between the heater 22 and the fixing belt 20 that slides over the heater 22 while the fixing belt 20 rotates, the inner circumferential face of the fixing belt 20 is applied with a lubricant such as grease. Hence, as the fixing belt 20 overheats, the lubricant is heated and vaporizes, generating fine particles. To address the circumstance, as described above, the resistive heat generator 60 according to the embodiment suppresses temperature increase of the fixing belt 20 in the lateral end spans, that is, the non-conveyance spans NS, in the longitudinal direction thereof, suppressing generation of the fine particles in the fixing device 9. Additionally, according to the embodiment, as illustrated in FIG. 10, the resistive heat generator 60 includes the projections 60a that are disposed in both lateral end spans of the heater 22 in the longitudinal direction C thereof and have the increased thickness. The projections 60a of the heater 22, that have the increased thickness, project toward the fixing belt 20 rightward in FIG. 2. Accordingly, the projections 60a prevent the lubricant interposed between the heater 22 and the fixing belt 20 from moving to the lateral end spans of the fixing belt 20 in the longitudinal direction thereof, suppressing generation of the fine particles.

According to the embodiment, the slopes 60a1 of the resistive heat generator 60 increase the thickness of the projections 60a serving as the lateral end portions of the resistive heat generator 60 in the longitudinal direction thereof, respectively. The projections 60a have a thickness that is greater than a thickness of the body 60c serving as the center portion of the resistive heat generator 60 in the longitudinal direction thereof. The slopes 60a1 gradually increase the thickness of the lateral end portions of the resistive heat generator 60 in the longitudinal direction thereof. Hence, the resistive heat generator 60 and the second insulating layer 53 of the heater 22 do not produce steps, respectively, that may damage the inner circumferential face of the fixing belt 20. In a case that the heater 22 includes the steps, the heater 22 pressing against the fixing belt 20 may produce steps on the fixing belt 20, causing a faulty toner image having faulty gloss and the like. To address the circumstance, the resistive heat generator 60 according to the embodiment suppresses formation of the faulty toner image. The center position B0 defines the center position of the heat generation span B in which the resistive heat generator 60 extends in the longitudinal direction thereof in FIG. 10. A direction directed from the center portion to the lateral end portion in the longitudinal direction C of the heater 22 defines a direction directed from the center position B0 to the lateral edge of the heat generation span B in any one of sides of the resistive heat generator 60, that are divided at the center position B0 in the longitudinal direction C of the heater 22.

A description is provided of modification examples of the resistive heat generator 60.

FIG. 11 illustrates a heater 22A according to an embodiment of the present disclosure. The heater 22A includes a resistive heat generator 60A including projections 60aA. Each of the projections 60aA includes a slope 60a1A that extends to the lateral edge of the heat generation span B in the longitudinal direction C of the heater 22A. The heater 22A includes a fixing belt side portion interposed between the base layer 50 and the fixing belt 20. The fixing belt side portion has a thickness that increases gradually toward the lateral edge of the heat generation span B in the longitudinal direction C of the heater 22A. For example, according to the embodiment, the slope 60a1A extends throughout an entirety of the projection 60aA, having an increased thickness, in a longitudinal direction of the resistive heat generator 60A. Accordingly, the slope 60a1A facilitates flow of the lubricant over a surface of the heater 22A toward a center portion of the resistive heat generator 60A in the longitudinal direction thereof. Accordingly, the projections 60aA prevent the lubricant from being accumulated in both lateral end spans in the longitudinal direction C of the heater 22A, where the fixing belt 20 and the heater 22A are subject to temperature increase, thus suppressing generation of the fine particles. The heater 22A presses against the fixing belt 20 with pressure that increases toward the lateral end spans of the fixing belt 20 in the longitudinal direction thereof. Accordingly, the fixing belt 20 presses against the sheet P with increased pressure at the fixing nip N in the lateral end spans of the fixing belt 20 in the longitudinal direction thereof. Consequently, the fixing belt 20 suppresses creases of the sheet P. The second insulating layer 53 is formed substantially evenly in the heat generation span B. Hence, the second insulating layer 53 is produced readily at reduced machining costs.

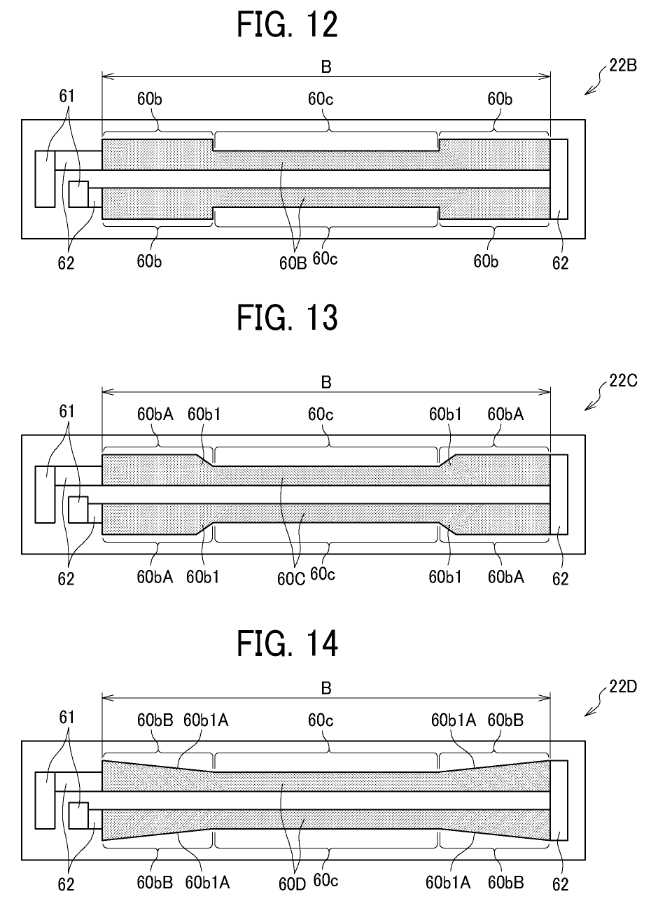

FIG. 12 illustrates a heater 22B including a resistive heat generator 60B including increased width portions 60b serving as lateral end portions and the body 60c serving as a center portion of the resistive heat generator 60B having the heat generation span B, like the heaters 22 and 22A depicted in FIGS. 10 and 11, respectively. A thickness of the increased width portion 60b is greater than the thickness of the body 60c in a thickness direction of the heater 22B. Additionally, a width of the increased width portion 60b is greater than a width of the body 60c in a short direction of the heater 22B. The increased width portions 60b suppress increase in thickness of the lateral end portions of the resistive heat generator 60B in a longitudinal direction thereof. Accordingly, the thickness of the lateral end portions of the resistive heat generator 60B in the longitudinal direction thereof does not increase excessively, preventing increase in friction between the heater 22B and the fixing belt 20. Additionally, the lubricant does not move to a center span of the heater 22B in a longitudinal direction thereof excessively, preventing increase in friction between the heater 22B and the fixing belt 20 similarly. The short direction of the heater 22B is different from the thickness direction of the heater 22B and is perpendicular to the longitudinal direction of the heater 22B.

FIG. 13 illustrates a heater 22C including a resistive heat generator 60C including increased width portions 60bA. The increased width portions 60bA include short direction slopes 60b1, respectively. The resistive heat generator 60C includes the increased width portions 60bA serving as lateral end portions and the body 60c serving as a center portion of the resistive heat generator 60C having the heat generation span B in a longitudinal direction of the resistive heat generator 60C. A thickness of the increased width portion 60bA is greater than the thickness of the body 60c. Additionally, the short direction slope 60b1 increases a width of the increased width portion 60bA in a short direction of the heater 22C. The short direction slope 60b1 increases the width of the resistive heat generator 60C in a short direction thereof gradually from an inboard end of the short direction slope 60b1, that abuts on the body 60c serving as the center portion of the heat generation span B, toward an outboard end of the short direction slope 60b1, that is disposed closer to the lateral edge of the heat generation span B than the inboard end is, in the longitudinal direction of the resistive heat generator 60C. Accordingly, the short direction slope 60b1 does not produce a step in the heater 22C contacting the fixing belt 20, that may produce a step on the fixing belt 20. Thus, the short direction slope 60b1 suppresses formation of a faulty toner image.

FIG. 14 illustrates a heater 22D including a resistive heat generator 60D including increased width portions 60bB. The increased width portions 60bB include short direction slopes 60b1A, respectively. The resistive heat generator 60D includes the increased width portions 60bB serving as lateral end portions and the body 60c serving as a center portion of the resistive heat generator 60D having the heat generation span B in a longitudinal direction of the resistive heat generator 60D. A thickness of each of the lateral end portions is greater than a thickness of the center portion. The short direction slope 60b1A extends to the lateral edge of the heat generation span B in the longitudinal direction of the resistive heat generator 60D. Accordingly, the short direction slope 60b1A moves the lubricant toward a center span of the heater 22D in a longitudinal direction thereof and suppresses creases of the sheet P effectively. Alternatively, each of the heaters 22B, 22C, and 22D depicted in FIGS. 12 to 14 may also employ a combination of the increased width portion 60b, 60bA, or 60bB and the projection 60a of the heater 22 depicted in FIG. 10 or the projection 60aA of the heater 22A depicted in FIG. 11.

The above describes the embodiments of the present disclosure. However, the technology of the present disclosure is not limited to the embodiments described above and is modified within the scope of the present disclosure.

According to the embodiments described above, a resistive heat generator (e.g., the resistive heat generators 60, 60A, 60B, 60C, and 60D) includes the lateral end portions (e.g., the projections 60a and 60aA and the increased width portions 60b, 60bA, and 60bB) and the center portion (e.g., the body 60c). The resistive heat generator has the heat generation span B in the longitudinal direction C of a heater (e.g., the heaters 22, 22A, 22B, 22C, and 22D). The thickness of each of the lateral end portions is greater than the thickness of the center portion. Alternatively, in a case that one lateral end span of the heater or a heated member (e.g., the fixing belt 20) barely overheats compared to another lateral end span of the heater or the heated member in the longitudinal direction C of the heater, for example, one of the lateral end portions of the resistive heat generator may have a thickness that is smaller than a thickness of another one of the lateral end portions of the resistive heat generator in the longitudinal direction C of the heater. For example, other component may contact the heated member in one lateral end span of the heated member in the longitudinal direction C of the heater, thus cooling the one lateral end span of the heated member.

According to the embodiments described above, the fixing device 9 employs a center-reference conveyance method in which the sheet P is conveyed through the fixing device 9 in a state in which the sheet P is centered on the fixing belt 20 in the width direction of the sheet P. Alternatively, in addition to the center-reference conveyance method, the fixing device 9 may also employ an edge-reference conveyance method in which the sheet P is conveyed through the fixing device 9 in a state in which the sheet P is aligned to one lateral end of the fixing belt 20 in the longitudinal direction thereof.

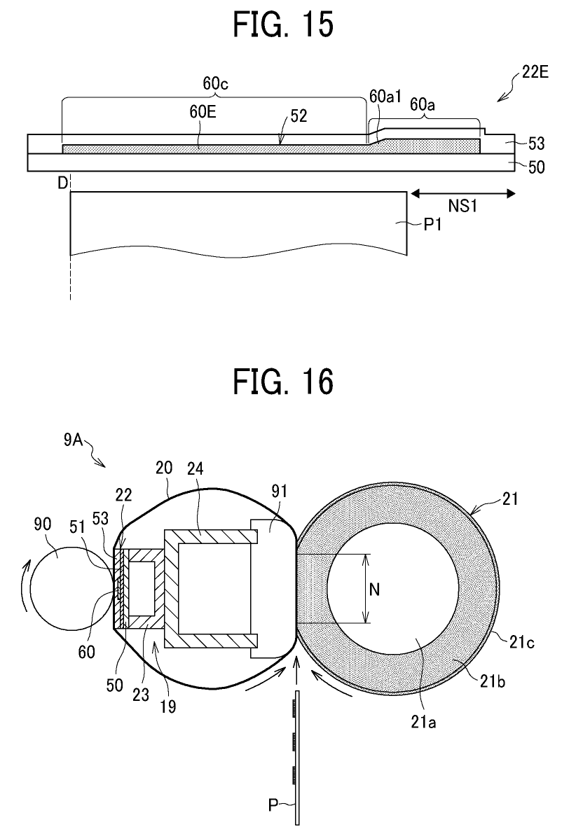

FIG. 15 illustrates a heater 22E installed in a fixing device that employs the edge-reference conveyance method in which the small sheet P1 is conveyed based on a reference position D disposed at one lateral end of the fixing belt 20 in the longitudinal direction thereof. The heater 22E includes a resistive heat generator 60E. Since the heater 22E employs the edge-reference conveyance method, as the small sheet P1 is conveyed, the small sheet P1 forms a non-conveyance span NS1 that is disposed outboard from the small sheet P1 in a longitudinal direction of the heater 22E at a right side in FIG. 15. The resistive heat generator 60E includes the projection 60a that is disposed in a lateral end span (e.g., a right span in FIG. 15) of the resistive heat generator 60E in a longitudinal direction thereof and disposed in the non-conveyance span NS1. The non-conveyance span NS1 is disposed opposite the reference position D via the small sheet P1 in the longitudinal direction of the heater 22E. The projection 60a has the thickness that is greater than the thickness of the body 60c disposed opposite the reference position D. Accordingly, the projection 60a decreases a heat generation amount of the resistive heat generator 60E in the lateral end span (e.g., the right span in FIG. 15), thus suppressing temperature increase of the lateral end span of the fixing belt 20 in the longitudinal direction thereof. FIG. 15 illustrates the fixing device that employs the edge-reference conveyance method and incorporates the projection 60a equivalent to the projection 60a depicted in FIG. 10. Alternatively, the fixing device may employ the projection 60aA depicted in FIG. 11, the increased width portion 60b depicted in FIG. 12, the increased width portion 60bA depicted in FIG. 13, or the increased width portion 60bB depicted in FIG. 14.

Application of the technology of the present disclosure is not limited to the color image forming apparatus 1000 depicted in FIG. 1 that forms a color toner image. The technology of the present disclosure is also applied to a monochrome image forming apparatus that forms a monochrome toner image, a copier, a printer, a facsimile machine, a multifunction peripheral (MFP) having at least two of copying, printing, facsimile, scanning, and plotter functions, or the like.

The embodiments of the present disclosure are also applied to fixing devices 9A, 9B, and 9C depicted in FIGS. 16 to 18, respectively, other than the fixing device 9 described above. The following briefly describes a construction of each of the fixing devices 9A, 9B, and 9C depicted in FIGS. 16 to 18, respectively.

A description is provided of the construction of the fixing device 9A.

As illustrated in FIG. 16, the fixing device 9A includes a pressing roller 90 and the nip formation pad 91. The pressing roller 90 is disposed opposite the pressure roller 21 via the fixing belt 20. The pressing roller 90 and the heater 22 sandwich the fixing belt 20 so that the heater 22 heats the fixing belt 20. On the other hand, the nip formation pad 91 is in contact with the inner circumferential face of the fixing belt 20 and disposed opposite the pressure roller 21 via the fixing belt 20. The stay 24 supports the nip formation pad 91. The nip formation pad 91 and the pressure roller 21 sandwich the fixing belt 20 to define the fixing nip N between the fixing belt 20 and the pressure roller 21.

A description is provided of the construction of the fixing device 9B.

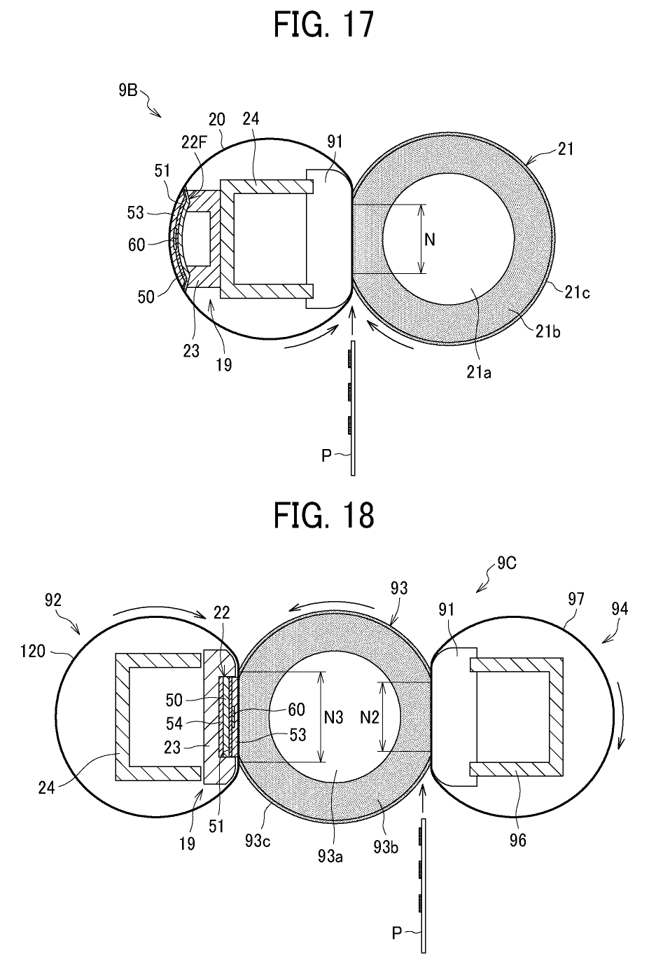

The fixing device 9B depicted in FIG. 17 eliminates the pressing roller 90 depicted in FIG. 16. The fixing device 9B includes a heater 22F. In order to ensure a contact length for which the heater 22F contacts the fixing belt 20 in the circumferential direction thereof, the heater 22F is an arc having a curvature that is equivalent to a curvature of the fixing belt 20. Other construction of the fixing device 9B is equivalent to that of the fixing device 9A depicted in FIG. 16.

A description is provided of the construction of the fixing device 9C.

The fixing device 9C depicted in FIG. 18 includes a heating assembly 92, a fixing roller 93 serving as a fixing rotator, and a pressure assembly 94 serving as an opposed assembly. The heating assembly 92 includes a heating belt 120 serving as a heated member or a rotator. The heating assembly 92 further includes the heater 22, the heater holder 23, and the stay 24 that are described in the embodiments above. The fixing roller 93 presses against the heating belt 120 to form a heating nip N3 therebetween, thus also serving as a pressure rotator. The fixing roller 93 includes a core metal 93a, an elastic layer 93b, and a surface layer 93c. The pressure assembly 94 is disposed opposite the heating assembly 92 via the fixing roller 93. The pressure assembly 94 includes the nip formation pad 91, a stay 96, and a pressure belt 97. The pressure belt 97 rotates and is formed into a loop within which the nip formation pad 91 and the stay 96 are disposed. The pressure belt 97 and the fixing roller 93 define a fixing nip N2 therebetween. As a sheet P is conveyed through the fixing nip N2, the fixing roller 93 heated at the heating nip N3 and the pressure belt 97 fix a toner image formed on the sheet P thereon under heat and pressure.

The embodiments of the present disclosure described above with reference to FIGS. 10 to 15 are also applied to the fixing devices 9A, 9B, and 9C. Accordingly, the fixing devices 9A, 9B, and 9C suppress temperature increase of the heated member in the lateral end span in a longitudinal direction of the heated member and attain downsizing.

The heating device 19 according to the embodiments of the present disclosure may be installed in devices other than the fixing devices 9, 9A, 9B, and 9C. For example, the heating device 19 according to the embodiments of the present disclosure is also applied to a dryer installed in an image forming apparatus employing an inkjet method. The dryer dries ink applied onto a sheet. Alternatively, the heating device 19 according to the embodiments of the present disclosure is also applied to a coater (e.g., a laminator) that thermally presses film serving as a coating member onto a surface of a sheet (e.g., paper) serving as a conveyed medium while a belt conveys the sheet. The heating device 19 according to the embodiments of the present disclosure is not limited to a belt heating device that heats a belt and may be a heating device that does not incorporate the belt. The embodiments of the present disclosure are also applied to the heating devices described above. Accordingly, the heating devices suppress temperature increase of the heated member in the lateral end span in the longitudinal direction of the heated member and attain downsizing.

A description is provided of aspects of the embodiments of the present disclosure.

A description is provided of a first aspect of the embodiments of the present disclosure.

A heating device (e.g., the heating device 19) includes a heated member (e.g., the fixing belt 20) and a heater (e.g., the heaters 22, 22A, 22B, 22C, 22D, and 22F).

The heater includes a base layer (e.g., the base layer 50) and a resistive heat generator (e.g., the resistive heat generators 60, 60A, 60B, 60C, and 60D). The heater heats the heated member. The heater is laminated. The resistive heat generator extends in a longitudinal direction (e.g., the longitudinal direction C) of the heater. The resistive heat generator includes lateral end portions (e.g., the projections 60a and 60aA and the increased width portions 60b, 60bA, and 60bB) and a center portion (e.g., the body 60c) in the longitudinal direction of the heater. The lateral end portions are disposed in lateral end spans of the resistive heat generator, respectively, in the longitudinal direction of the heater. The center portion is disposed in a center span of the resistive heat generator in the longitudinal direction of the heater. At least one of the lateral end portions has a thickness that is greater than a thickness of the center portion. As the at least one of the lateral end portions has the greater thickness, the at least one of the lateral end portions generates heat in a heat generation amount that is smaller than a heat generation amount of the center portion.

A description is provided of a second aspect of the embodiments of the present disclosure.

A heating device (e.g., the heating device 19) includes a heated member (e.g., the fixing belt 20) and a heater (e.g., the heaters 22, 22A, 22B, 22C, 22D, and 22F).

The heater includes a base layer (e.g., the base layer 50) and a resistive heat generator (e.g., the resistive heat generators 60, 60A, 60B, 60C, and 60D). The heater heats the heated member. The heater is laminated. The resistive heat generator extends in a longitudinal direction (e.g., the longitudinal direction C) of the heater. The resistive heat generator includes lateral end portions (e.g., the projections 60a and 60aA and the increased width portions 60b, 60bA, and 60bB) and a center portion (e.g., the body 60c) in the longitudinal direction of the heater. The center portion and the lateral end portions form a series circuit. At least one of the lateral end portions has a thickness that is greater than a thickness of the center portion.

A description is provided of a third aspect of the embodiments of the present disclosure.

In the heating device according to the first aspect or the second aspect, the lateral end portion of the resistive heat generator includes a slope (e.g., the slope 60a1) that increases the thickness of the lateral end portion from an inboard end of the slope, that abuts on the center portion of the resistive heat generator, to an outboard end of the slope, that is disposed closer to a lateral edge of the resistive heat generator than the inboard end is, in the longitudinal direction of the heater.

A description is provided of a fourth aspect of the embodiments of the present disclosure.

In the heating device according to the first aspect or the second aspect, the lateral end portion of the resistive heat generator includes a slope (e.g., the slope 60a1A) that increases the thickness of the lateral end portion from an inboard end of the slope, that abuts on the center portion of the resistive heat generator, to an outboard end of the slope, that defines a lateral edge of the resistive heat generator, in the longitudinal direction of the heater.

A description is provided of a fifth aspect of the embodiments of the present disclosure.

In the heating device according to any one of the first aspect to the fourth aspect, the heater has a short direction that is perpendicular to the longitudinal direction of the heater and is different from a thickness direction of the heater. A width of the lateral end portion (e.g., the increased width portions 60b, 60bA, and 60bB) of the resistive heat generator is greater than a width of the center portion of the resistive heat generator in the short direction of the heater.

A description is provided of a sixth aspect of the embodiments of the present disclosure.

In the heating device according to the fifth aspect, the lateral end portion of the resistive heat generator includes a short direction slope (e.g., the short direction slope 60b1). The short direction slope increases the width of the lateral end portion in the short direction of the heater from an inboard end of the short direction slope, that abuts on the center portion, to an outboard end of the short direction slope, that is disposed closer to the lateral edge of the resistive heat generator than the inboard end is, in the longitudinal direction of the heater.

A description is provided of a seventh aspect of the embodiments of the present disclosure.

In the heating device according to the fifth aspect, the lateral end portion of the resistive heat generator includes a short direction slope (e.g., the short direction slope 60b1A) that increases the width of the lateral end portion from an inboard end of the short direction slope, that abuts on the center portion of the resistive heat generator, to an outboard end of the short direction slope, that defines the lateral edge of the resistive heat generator, in the longitudinal direction of the heater.

A description is provided of an eighth aspect of the embodiments of the present disclosure.

A heating device (e.g., the heating device 19) includes a heated member (e.g., the fixing belt 20) and a heater (e.g., the heater 22E).

The heated member heats a recording medium (e.g., the sheets P and P1). The heater includes a base layer (e.g., the base layer 50) and a resistive heat generator (e.g., the resistive heat generator 60E). The heater heats the heated member. The heater is laminated. The resistive heat generator extends in a longitudinal direction (e.g., the longitudinal direction C) of the heater. The recording medium is conveyed over the heated member based on a reference position (e.g., the reference position D) disposed at one lateral end of the heated member in the longitudinal direction of the heater. The resistive heat generator includes a first lateral end portion (e.g., the body 60c) in the longitudinal direction of the heater, that is disposed opposite the reference position, and a second lateral end portion (e.g., the projection 60a) in the longitudinal direction of the heater. A thickness of the second lateral end portion is greater than a thickness of the first lateral end portion. As the second lateral end portion has the greater thickness, the second lateral end portion generates heat in a heat generation amount that is smaller than a heat generation amount of the first lateral end portion.

A description is provided of a ninth aspect of the embodiments of the present disclosure.

A heating device (e.g., the heating device 19) includes a heated member (e.g., the fixing belt 20) and a heater (e.g., the heater 22E).

The heated member heats a recording medium (e.g., the sheets P and P1). The heater includes a base layer (e.g., the base layer 50) and a resistive heat generator (e.g., the resistive heat generator 60E). The heater heats the heated member. The heater is laminated. The resistive heat generator extends in a longitudinal direction (e.g., the longitudinal direction C) of the heater. The recording medium is conveyed over the heated member based on a reference position (e.g., the reference position D) disposed at one lateral end of the heated member in the longitudinal direction of the heater. The resistive heat generator includes a first lateral end portion (e.g., the body 60c) in the longitudinal direction of the heater, that is disposed opposite the reference position, and a second lateral end portion (e.g., the projection 60a) in the longitudinal direction of the heater. The first lateral end portion and the second lateral end portion form a series circuit. A thickness of the second lateral end portion is greater than a thickness of the first lateral end portion.

A description is provided of a tenth aspect of the embodiments of the present disclosure.

In the heating device according to the eighth aspect or the ninth aspect, the second lateral end portion of the resistive heat generator includes a slope (e.g., the slope 60a1) that increases the thickness of the second lateral end portion from an inboard end of the slope, that abuts on the first lateral end portion of the resistive heat generator, to an outboard end of the slope, that is disposed closer to a lateral edge of the resistive heat generator than the inboard end is, in the longitudinal direction of the heater.

A description is provided of an eleventh aspect of the embodiments of the present disclosure.

In the heating device according to the eighth aspect or the ninth aspect, the second lateral end portion of the resistive heat generator includes a slope (e.g., the slope 60a1A) that increases the thickness of the second lateral end portion from an inboard end of the slope, that abuts on the first lateral end portion of the resistive heat generator, to an outboard end of the slope, that defines a lateral edge of the resistive heat generator, in the longitudinal direction of the heater.

A description is provided of a twelfth aspect of the embodiments of the present disclosure.

In the heating device according to any one of the eighth aspect to the eleventh aspect, the heater has a short direction that is perpendicular to the longitudinal direction of the heater and is different from a thickness direction of the heater. A width of the second lateral end portion (e.g., the increased width portions 60b, 60bA, and 60bB) of the resistive heat generator is greater than a width of the first lateral end portion (e.g., the body 60c) of the resistive heat generator in the short direction of the heater.

A description is provided of a thirteenth aspect of the embodiments of the present disclosure.

In the heating device according to the twelfth aspect, the second lateral end portion of the resistive heat generator includes a short direction slope (e.g., the short direction slope 60b1). The short direction slope increases the width of the second lateral end portion in the short direction of the heater from an inboard end of the short direction slope, that abuts on the first lateral end portion of the resistive heat generator, to an outboard end of the short direction slope, that is disposed closer to the lateral edge of the resistive heat generator than the inboard end is, in the longitudinal direction of the heater.

A description is provided of a fourteenth aspect of the embodiments of the present disclosure.

In the heating device according to the twelfth aspect, the second lateral end portion of the resistive heat generator includes a short direction slope (e.g., the short direction slope 60b1A) that increases the width of the second lateral end portion from an inboard end of the short direction slope, that abuts on the first lateral end portion of the resistive heat generator, to an outboard end of the short direction slope, that defines the lateral edge of the resistive heat generator, in the longitudinal direction of the heater.

A description is provided of a fifteenth aspect of the embodiments of the present disclosure.

A fixing device (e.g., the fixing devices 9, 9A, 9B, and 9C) includes the heating device according to any one of the first aspect to the fourteenth aspect. The fixing device fixes an image on a recording medium (e.g., the sheets P and P1) under heat.

A description is provided of a sixteenth aspect of the embodiments of the present disclosure.

An image forming apparatus (e.g., the image forming apparatus 1000) includes the fixing device according to the fifteenth aspect.

Accordingly, the heating device, the fixing device, and the image forming apparatus suppress temperature increase of the heated member in the lateral end span thereof in the longitudinal direction of the heater.

According to the embodiments described above, the fixing belt 20 or the heating belt 120 serves as a heated member. Alternatively, the heated member may be a fixing film, a fixing sleeve, or the like.

According to the embodiments described above, the pressure roller 21 or the fixing roller 93 serves as a pressure rotator. Alternatively, the pressure rotator may be a pressure belt or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
a heater that is laminated; and
a heated member to be heated by the heater,
the heater including:
a base layer; and
a resistive heat generator mounted on the base layer, the resistive heat generator extending in a longitudinal direction of the heater,
the resistive heat generator including:
a first heat generating portion having a first thickness, the first heat generating portion to generate heat in a first heat generation amount; and
a second heat generating portion disposed in a lateral end span of the resistive heat generator in the longitudinal direction of the heater, the second heat generating portion having a second thickness that is greater than the first thickness of the first heat generating portion, the second heat generating portion to generate heat in a second heat generation amount that is smaller than the first heat generation amount of the first heat generating portion.

2. The heating device according to claim 1,
wherein the first heat generating portion and the second heat generating portion form a series circuit.

3. The heating device according to claim 1,
wherein the second heat generating portion includes a longitudinal direction slope that increases the second thickness from an inboard end of the longitudinal direction slope to an outboard end of the longitudinal direction slope in the longitudinal direction of the heater,
wherein the inboard end of the longitudinal direction slope abuts on the first heat generating portion, and
wherein the outboard end of the longitudinal direction slope is disposed closer to a lateral edge of the resistive heat generator in the longitudinal direction of the heater than the inboard end of the longitudinal direction slope is.

4. The heating device according to claim 1,
wherein the second heat generating portion includes a longitudinal direction slope that increases the second thickness from an inboard end of the longitudinal direction slope to an outboard end of the longitudinal direction slope in the longitudinal direction of the heater,
wherein the inboard end of the longitudinal direction slope abuts on the first heat generating portion, and
wherein the outboard end of the longitudinal direction slope defines a lateral edge of the resistive heat generator in the longitudinal direction of the heater.

5. The heating device according to claim 1,
wherein the heater has a short direction that is perpendicular to the longitudinal direction of the heater and is different from a thickness direction of the heater,
wherein the first heat generating portion has a first width in the short direction of the heater, and
wherein the second heat generating portion has a second width that is greater than the first width of the first heat generating portion in the short direction of the heater.

6. The heating device according to claim 5,
wherein the second heat generating portion includes a short direction slope having the second width that increases from an inboard end of the short direction slope to an outboard end of the short direction slope in the longitudinal direction of the heater,
wherein the inboard end of the short direction slope abuts on the first heat generating portion, and
wherein the outboard end of the short direction slope is disposed closer to a lateral edge of the resistive heat generator in the longitudinal direction of the heater than the inboard end of the short direction slope is.

7. The heating device according to claim 5,
wherein the second heat generating portion includes a short direction slope that increases the second thickness from an inboard end of the short direction slope to an outboard end of the short direction slope in the longitudinal direction of the heater,
wherein the inboard end of the short direction slope abuts on the first heat generating portion, and
wherein the outboard end of the short direction slope defines a lateral edge of the resistive heat generator in the longitudinal direction of the heater.

8. The heating device according to claim 1,
wherein the heated member heats a recording medium, and
wherein the recording medium is conveyed over the heated member based on a reference position disposed opposite the first heat generating portion.

9. The heating device according to claim 1,
wherein the resistive heat generator further includes another second heat generating portion having the second thickness that is greater than the first thickness of the first heat generating portion,
wherein said another second heat generating portion is disposed in another lateral end span of the resistive heat generator in the longitudinal direction of the heater, and
wherein the first heat generating portion is disposed in a center span of the resistive heat generator in the longitudinal direction of the heater.

10. The heating device according to claim 1,
wherein the second heat generating portion is disposed in a non-conveyance span in the longitudinal direction of the heater, the non-conveyance span where a recording medium is not conveyed over the heated member.

11. The heating device according to claim 1,
wherein the heated member includes a fixing belt.

12. A fixing device comprising:
a heating device to heat a recording medium bearing an image; and
a pressure rotator disposed opposite the heating device, the pressure rotator to fix the image on the recording medium together with the heating device,
the heating device including:
a heater that is laminated; and
a heated member to be heated by the heater,
the heater including:
a base layer; and
a resistive heat generator mounted on the base layer, the resistive heat generator extending in a longitudinal direction of the heater,
the resistive heat generator including:
a first heat generating portion having a first thickness, the first heat generating portion to generate heat in a first heat generation amount; and
a second heat generating portion disposed in a lateral end span of the resistive heat generator in the longitudinal direction of the heater, the second heat generating portion having a second thickness that is greater than the first thickness of the first heat generating portion, the second heat generating portion to generate heat in a second heat generation amount that is smaller than the first heat generation amount of the first heat generating portion.

13. The fixing device according to claim 12,
wherein the first heat generating portion and the second heat generating portion form a series circuit.

14. The fixing device according to claim 12,
wherein the heated member heats the recording medium, and
wherein the recording medium is conveyed over the heated member based on a reference position disposed opposite the first heat generating portion.

15. The fixing device according to claim 12,
wherein the pressure rotator includes a pressure roller.

16. An image forming apparatus comprising:
an image forming device to form an image; and
a fixing device to fix the image on a recording medium,
the fixing device including:
a heating device to heat the recording medium bearing the image; and
a pressure rotator disposed opposite the heating device,
the heating device including:
a heater that is laminated; and
a heated member to be heated by the heater,
the heater including:
a base layer; and
a resistive heat generator mounted on the base layer, the resistive heat generator extending in a longitudinal direction of the heater,
the resistive heat generator including:
a first heat generating portion having a first thickness, the first heat generating portion to generate heat in a first heat generation amount; and
a second heat generating portion disposed in a lateral end span of the resistive heat generator in the longitudinal direction of the heater, the second heat generating portion having a second thickness that is greater than the first thickness of the first heat generating portion, the second heat generating portion to generate heat in a second heat generation amount that is smaller than the first heat generation amount of the first heat generating portion.

17. The image forming apparatus according to claim 16,
wherein the first heat generating portion and the second heat generating portion form a series circuit.

18. The image forming apparatus according to claim 16,
wherein the heated member heats the recording medium, and
wherein the recording medium is conveyed over the heated member based on a reference position disposed opposite the first heat generating portion.
